(19) United States
(12) Patent Application Publication
(10) Pub. No.: US 2016/0013829 A1
(43) Pub. Date: Jan. 14, 2016

(54) CELL PHONE CASE WITH DIGITAL PICTURE DISPLAY

(71) Applicant: Shayla Battle, Raeford, NC (US)

(72) Inventor: Shayla Battle, Raeford, NC (US)

(21) Appl. No.: 14/799,010

(22) Filed: Jul. 14, 2015

Related U.S. Application Data
(60) Provisional application No. 62/024,232, filed on Jul. 14, 2014.

(51) Int. Cl. H04B 1/3888; H04B 1/3883

(52) U.S. Cl. CPC H04B 1/3888; H04B 1/3883

(57) ABSTRACT

A cell phone case for receiving and holding a cell phone. Formed in the back of the case is a digital picture display. Also incorporated into the cell phone case is a digital media memory card and a battery. A processor circuit functions to communicate content from the digital media memory card to the digital picture display.

This application claims priority under 35 U.S.C. §119(e) from the following U.S. provisional application: Application Ser. No. 62/024,232 filed on Jul. 14, 2014. That application is incorporated in its entirety by reference herein.

### FIELD OF THE INVENTION

The present invention relates to cell phone cases, and more particularly to a cell phone case having a digital picture display incorporated into the back thereof.

### SUMMARY OF THE INVENTION

The present invention relates to a cell phone case having a digital picture display incorporated into the back of the cell phone case. The digital picture display includes a frame and a display screen that is seated in a backside of the cell phone case. Thus, the cell phone case and the digital picture display form an integral unit.

In one embodiment, the digital picture display incorporated into the back of the cell phone case is interfaced with the cell phone case and/or a cell phone held in the cell phone case. This allows various communications to be exchanged between the digital picture display and the cell phone case and/or a cell phone secured within the cell phone case.

### BRIEF DESCRIPTION OF THE DRAWINGS

FIG. 1 is a perspective view of the cell phone case of the present invention showing the digital picture display incorporated therein.

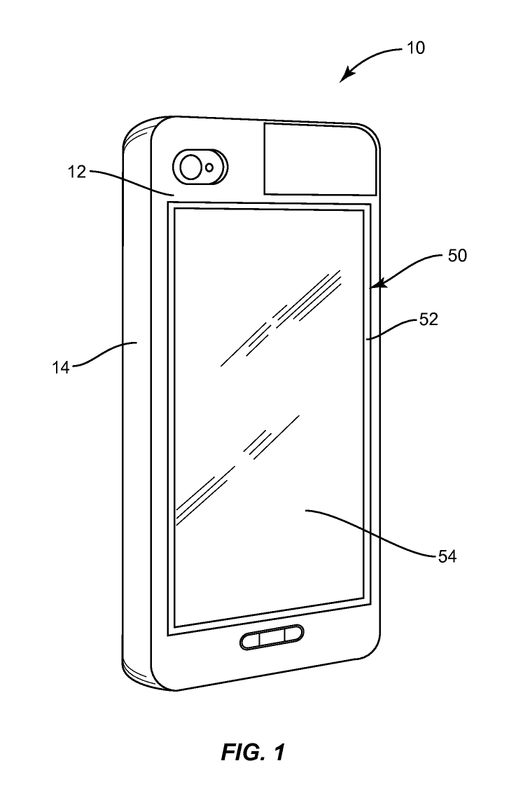

FIG. 2 is a plan view of the back of the cell phone case showing the digital picture display incorporated into the cell phone case.

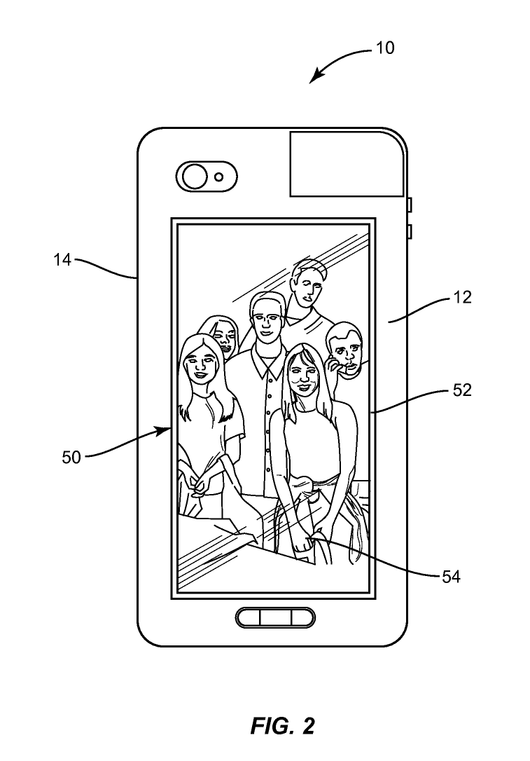

FIG. 3 shows the cell phone case holding a cell phone.

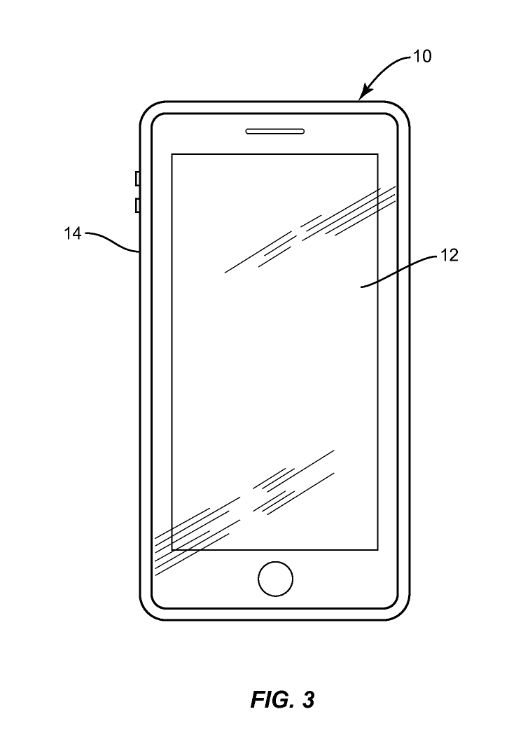

FIG. 4 is a view of the cell phone case and illustrates another embodiment of the present invention.

FIG. 5 is a schematic illustration illustrating a processor circuit interface between a digital media memory card and the digital picture display.

### DESCRIPTION OF EXEMPLARY EMBODIMENTS OF THE NEW CELL PHONE CASE

The cell phone case is shown in the attached drawings and indicated generally by the numeral 10. The cell phone case 10 is similar in many respects to conventional cases that are adapted to receive and hold various mobile or cell phones such as the “iPhone”, “Android” phone and others. The cell phone case 10 can include features found in these commercially available cases. A brief description of the cell phone case 10 shown in the drawings is presented below.

Cell phone case 10 includes a back 12 and surrounding edge structure 14. The surrounding edge structure 14 forms a cavity in the case for receiving a cell phone. In the lower portion of the cell phone case 10, there is provided an auxiliary power supply. The auxiliary power supply is positioned in the lower portion of the cell phone case so as to connect to a cell phone when the cell phone is secured within the case. In conventional fashion, this auxiliary power supply or auxiliary battery provides power to the cell phone when the cell phone experiences a low charge. As with conventional cell phone cases, the auxiliary power supply can be connected to an external power source for charging the same or charging a cell phone contained and secured within the cell phone case. On the back of the cell phone case, there can be provided indicia that indicates the amount of charge or power that remains in the auxiliary power source incorporated into the cell phone case 10. There are numerous access openings in the back 12 and surrounding edge 14. These access openings provide an opening for a camera lens disposed on the backside of a cell phone, an opening for an audio outlet of the cell phone, and one or more openings along the lower edge of the cell phone case 10 to accommodate charging terminals or output or input terminals.

Formed in the back 12 of the cell phone case 10 is a digital picture display indicated generally by the numeral 50. The digital picture display 50 can form an integral part of the back 12 of the case 10. In an alternate embodiment, the digital picture display 50 can be detachable from the case and used as a standalone product.

Details of the digital picture display 50 are not dealt with herein because such is not material per se to the present invention and, further, the basic structure and functionality of digital picture displays are well known and appreciated by those skilled in the art. However, it may be beneficial to review some basic structure and function of the digital picture display 50 which is incorporated into the back 12 of the cell phone case 10. The digital picture display 50 comprises a surrounding frame structure 52. Disposed interiorly of the surrounding frame structure 52 is a display screen 54 which may be configured such that it is a touch screen.

First, the cell phone case 10 and the digital picture display 50 are designed such that the digital picture display is electrically interfaced with the case and can be electrically and/or communicatively interfaced with a cell phone housed within the case. This enables the digital picture display to be powered by the auxiliary battery or power supply that is incorporated into the case 10 and will permit communication between the cell phone in the case and the digital picture display 50.

The digital picture display includes a processor that is adapted to interface with a communication module, a display module and a memory wherein the memory provides various options and features. The memory may include various types of memory. For example, the memory may include a disc drive, flash memory or an optical memory. Other examples of an appropriate memory include a removable media such as a digital media memory card, stick or disc. The memory is accessible to the processor and may provide instructions to the processor. The processor is designed to implement various features of the digital picture display 50 based on stored instructions. Furthermore, the memory may store a set of digital photographs, data or information associated with the digital photograph, as well as audio files. For example, the memory may store a digital photograph image along with data or information in a table form associating caller identification information with each digital photograph and image.

The digital photograph display 50 may employ one or more communication modules that enable the digital picture display to communicate directly with a cell phone secured in the case 10 or to communicate with a device that is external to the case.

In addition, the processor included in the digital picture display may interface with a microphone, a speaker or a clock that forms a part of the digital picture display. For example, the processor may cause the display to present day and time information by interfacing with a clock.

In another example, the processor can be configured to respond to incoming telephone call data associated with a cell phone secured to the case 10. The processor can manipulate the display module in response to or based on incoming telephone calls. For example, the processor may display caller identification data, along with a digital photograph on the display screen 54.

In another example, the digital picture display 50 can be used to access an address book stored in memory. The processor may allow a user to display address information from the address book. Additional address book entries may be received from the cell phone that is secured to the case or from a personal computer, and these additional addresses can be stored in memory in the digital picture display.

It may be beneficial to summarize some of the additional features and functionality that is provided in the cell phone case having associated therewith the digital picture display 50. In one embodiment, the digital picture display interfaces with the cell phone secured in the case 10 and manipulates images displayed on the display screen 54 in response to incoming caller information. For example, the digital picture displayed 50 may select an image for display based on incoming caller information to the associated cell phone. In another example, the digital picture display can function as a speaker phone. In a particular example, the speaker phone may include a touch screen feature which is configured to provide a number pad interface for dialing numbers. That is, the user can dial a number for an outgoing call from the cell phone by entering the number on a touch pad interface on the screen 54 of the digital picture display.

In another exemplary embodiment, the present invention may include computer readable media including computer implemented instructions that are operable by the processor in the digital picture display to perform a process of routing photographic images to the digital picture display. This feature may provide for receiving a digital photographic image and associating the digital photographic image caller information to produce association data and transferring the association data to the digital picture display. This will enable a user to associate photographic images with cell phone data, including phone numbers.

Finally, one of the most fundamental features of the present invention is that of being able to load the digital picture device with a multitude of photographic images that can easily be accessed by the user. Furthermore, because the digital picture display that is incorporated into the case is interfaced with the cell phone, it follows that information and data including photographs that are stored on a cell phone can be transmitted and stored on the digital picture display 50. In addition, information and data stored on the digital picture display can be transmitted and stored on the cell phone.

It is appreciated that the present invention includes one or more terminals associated with both the digital picture display and an appropriate terminal of the cell phone in order to permit communications between the digital picture display and the cell phone. As an alternative, the communication link can be provided by a hardwire that interconnects the cell phone with the digital picture display.

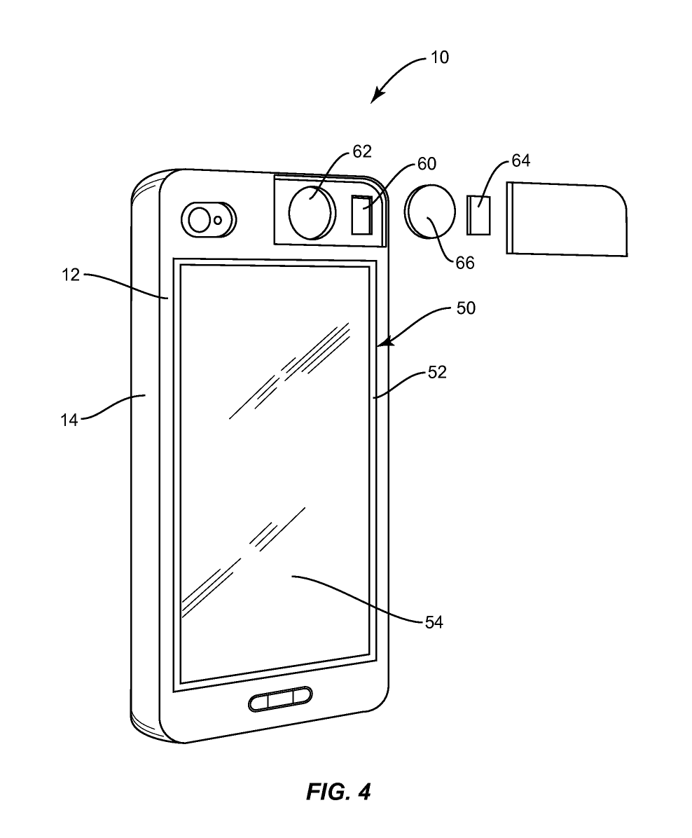

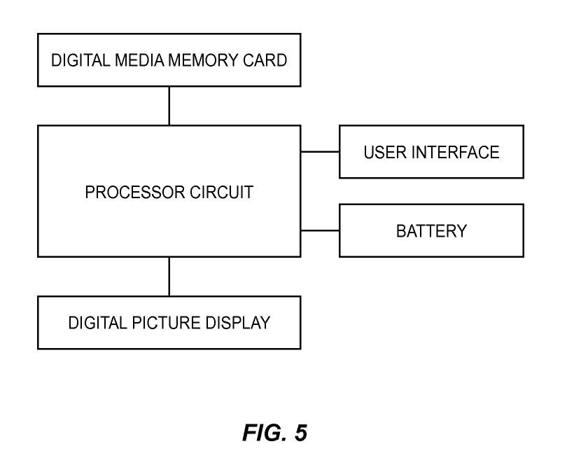

With reference to FIGS. 4 and 5, there is shown therein another embodiment of the present invention. In this case, cell phone case 10 is a standalone device that, while designed to receive and hold a cell phone, does not depend on the cell phone for its functionality. In this embodiment, cell phone case 10 includes a digital media memory card cavity 60 formed in the body of the cell phone case 10. In addition, there is another cavity, a battery cavity 62, formed in the body. Disposed in the cavity 60 is a digital media memory card 64 that is designed to store content such as photographs which can be downloaded onto the card. Disposed in the battery compartment 62 is a standalone battery 66 that is independent of the cell phone that is designed to be received and held in the case. A processor circuit or other appropriate operational interface is operatively connected between the digital media memory card 64 and the digital picture display 50 for transferring content from the digital media memory card to the digital picture display. People skilled in the art will appreciate that there are other interfaces appropriate for incorporating into the case 10 that will function to transmit stored media on the digital media memory card 64 to the digital picture display 50. In addition, there is a user interface incorporated into the cell phone case 10 that enables a user to manipulate the information or content on the digital media memory card 64 onto the digital picture display 50.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

What is claimed is:

1. A cell phone case for receiving and holding a cell phone, comprising:
a back;
a surrounding edge structure;
the surrounding edge structure forming a cavity for receiving and holding the cell phone;
access openings formed in the case for permitting access to terminals or features of the cell phone;
a digital picture display disposed on the back of the case with the digital picture display facing outwardly from the case;
a memory card cavity formed in the case;
a digital media memory card secured in the memory card cavity in the case;
a processor circuit operatively connected between the digital media memory card and the digital picture display for receiving content associated with the digital media memory card and displaying the content on the digital picture display formed in the back of the case;
a battery compartment formed in the case; and
a battery secured in the battery compartment of the case for powering the processor circuit.

2. The cell phone case of claim 1 including an auxiliary power supply incorporated into the cell phone case and operative to power a cell phone secured within the case.

3. The cell phone case of claim 1 wherein the digital picture display is detachably mounted to a back portion of the cell phone case.
